(19) United States
(12) Patent Application Publication
(10) Pub. No.: US 2005/0286439 A1
(43) Pub. Date: Dec. 29, 2005

(54) Method of testing a router, and a test system

(76) Inventors: Marc Capelle, Chilly (FR); Sovatha Chou, Noisiel (FR); Francois Billaut, Paris (FR)

Correspondence Address: YOUNG & THOMPSON, 745 SOUTH 23RD STREET, 2ND FLOOR, ARLINGTON, VA, 22202, US

(21) Appl. No.: 11/147,267

(22) Filed: Jun. 8, 2005

(30) Foreign Application Priority Data
Jun. 8, 2004 (EP) 04291431.7

(51) Int. Cl. H04L 12/26

(52) U.S. Cl. 370/252

(57) ABSTRACT

This method of testing a router in a test environment that is isolated from an operational telecommunications network comprises initially collecting data from a node of said operational network by copying data packets being conveyed thereby, and then: a step of modifying collected data packets, this step comprising at least one substep of replacing the identity data of the original senders and receivers of the collected packets with identification data for senders and receivers in the test environment; and a step of testing the router and comprising at least one substep of routing modified data packets via said router in said test environment.

The present invention relates to a method of testing a router in a test environment that is isolated from an operational telecommunications network, and it also relates to a test system.

### BACKGROUND OF THE INVENTION

Test campaigns are often necessary prior to installing new routing equipment in an operational network, both when replacing existing equipment and when installing new equipment.

In conventional manner, routers for testing, also referred to as devices under test (DUTs) are usually placed in a test environment that is isolated from the operational network and that comprises a small number of other pieces of equipment that are supposed to reproduce an operational network as faithfully as possible. The isolated test system or environment enables tests to be performed that take account of the hardware and software configuration of the DUT and also of its position within the topology of the operational network.

Conventional test environments and methods thus make it possible to test that the DUT complies with protocols, i.e. that it complies with the standards in force on the operational network, and that it is interoperable, i.e. it is compatible with other pieces of equipment already in place.

The performance of the DUT and in particular the protocol performance of the manufacturer's stub, i.e. the performance of the software core of the DUT, relating to handling a given protocol, are tested in part only, since the test environment does not reflect the real protocol activity on the operational network.

The rapid increase in traffic on telecommunications networks, and the development of new routing protocols using advanced functions that require large amounts of capacity, are making it more and more critical to obtain prior knowledge about the protocol performance of a DUT.

### OBJECTS AND SUMMARY OF THE INVENTION

An object of the invention is to define a test method and a test environment or system that enable the protocol performance of a router to be tested effectively.

To this end, the present invention provides a method of testing a router in a test environment isolated from an operational telecommunications network, wherein, after collecting data from a node of said operational network by copying data packets being conveyed thereby, said method comprising:

a step of modifying collected data packets, this step comprising at least one substep of replacing the identity data of the original senders and receivers of the collected packets with identification data for senders and receivers in the test environment; and

a step of testing the router and comprising at least one substep of routing modified data packets via said router in said test environment.

This test method makes it possible to test the router in a situation that corresponds substantially to a situation in an operational network, thereby obtaining a meaningful reading of its protocol performance.

Other characteristics of the method of the invention are defined in the claims that depend on claim 1.

The invention also provides a test system isolated from an operational telecommunications network, the system being of the type comprising one or more simulation routers connected to a router under test, a database containing test data packets, and a control unit suitable for controlling routing by said simulation routers of data packets from said database through said router under test, wherein said database contains data packets collected from a node of an operational network and modified in order to replace the identity data of the original senders and receivers of the data packets collected with identification data for senders and receivers in the test environment.

### BRIEF DESCRIPTION OF THE DRAWINGS

The invention will be better understood on reading the following description given purely by way of example and made with reference to the accompanying drawings, in which:

FIG. 1 is a diagram of an operational network on which data is collected;

FIG. 2 is a flow chart showing a method of the invention; and

FIG. 3 shows the test system of the invention.

### MORE DETAILED DESCRIPTION

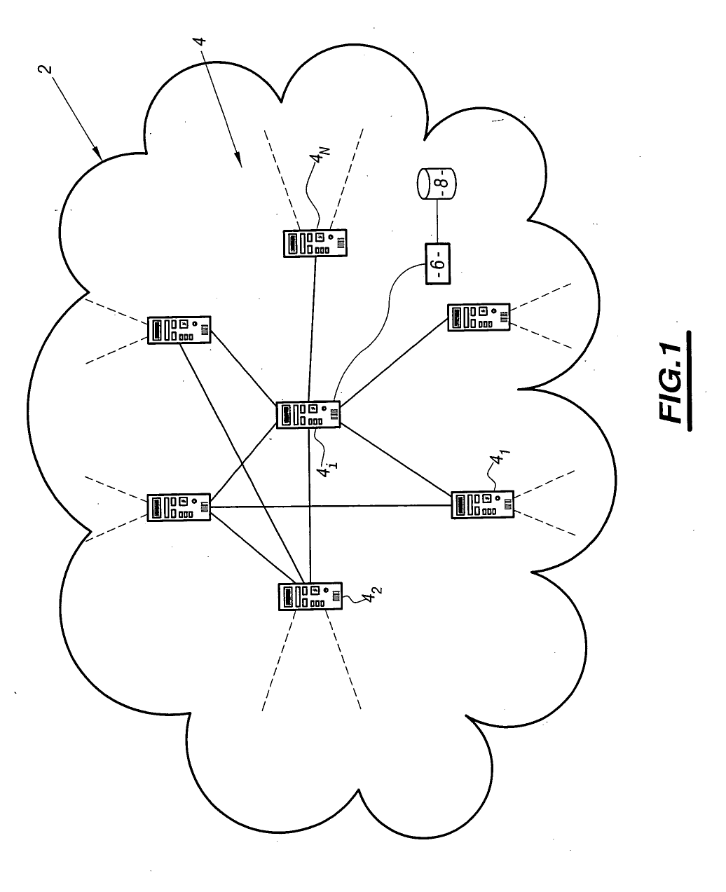

The operational telecommunications network 2 shown in FIG. 1 comprises some number of routers given overall reference 4 and particular references 4₁ to 4_{N}.

Each router 4 is connected to a varying number of other routers in order to determine routes or paths for transferring information.

Some of the routers are adapted to handle routing protocols between domains (exterior gateway protocol), and/or protocols for routing within a domain (interior gateway protocol).

The protocol BGP4 (for border gateway protocol, version 4) is a routing protocol of the exterior gateway protocol family. That protocol is said to be connected, i.e. it requires sessions to be set up between routers. The greater the number of routers within a network, the greater the number of sessions. An optimization applied to the BGP4 protocol consists in adding a route reflector function to certain routers that act as entry points for certain other routers in order to reduce the number of connections. Consequently, these route reflectors constitute critical items of equipment.

In the method of the invention, data collector means 6 for collecting routing information conveyed over the network 2 are themselves connected to a node formed by a given router 4ᵢ. These data collector means 6 are also connected to a database 8.

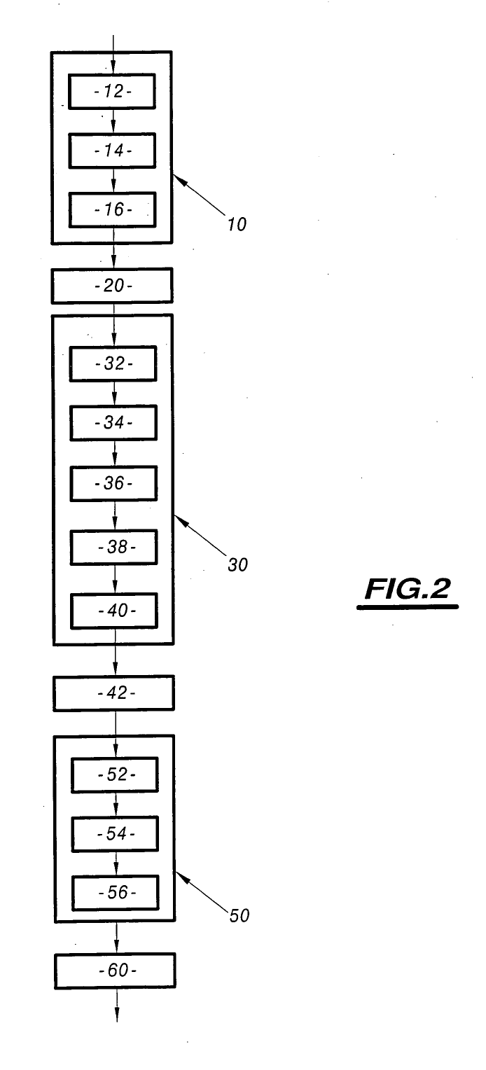

In the embodiment described, the data collector means 6 are obtained using a supervisor tool known under the commercial name “SCEPTRE” that implements a method of observing a communications network of the kind defined in the French patent application published on Jul. 18, 2003 under the No. 2 834 848. The implementation of that method is described in greater detail with reference to FIG. 2.

FIG. 2 is a flow chart for the method of the invention, and more particularly for the portion of the test method that corresponds to testing the protocol performance of a router device under test (DUT).

The method described thus corresponds to testing the performance of a DUT relative to a given protocol, to verify conformance with standards in force and interoperability with equipment that is already in place, and also the extensibility of the DUT, all of which can be tested by means of known methods that can freely be combined with the method of the invention.

In the embodiment described, the protocol used is BGP4, which is an exterior gateway protocol, and a full description thereof can be found on the Internet site of the Internet Engineering Task Force (IETF).

The BGP4 protocol is selected because it is highly complex, so handling it requires significant resources in the computer and the memory of the router.

The method of the invention begins with a step 10 of selecting data from the node 4ᵢ in the operational network 2.

This step 10 comprises a substep 12 of positioning the data collector means 6 on a node 4ᵢ that has characteristics similar to those of the position that is to be occupied by the DUT, in particular in terms of traffic loading.

This substep 12 is followed by a substep 14 of copying data packets conveyed over the operational network 2 via the node 4ᵢ, and a substep 16 of selecting from amongst the copied data packets those data packets that correspond to the BGP4 protocol.

Various implementations of substeps 14 and 16 are known in the state of the art, in particular from the French patent application published on Jul. 18, 2003 under the No. 2 834 848. In particular, in that application as published, the passage extending from page 7, line 20 to page 12, line 9 describes a method of collecting information from a network on the principles set out below.

All of the data packets that are to be processed by the router 4ᵢ pass via a control unit of the router. They are then filtered as a function of predetermined criteria and copied when they satisfy these criteria, one of the criteria possibly being the nature of the protocol used for conveying data.

The substeps 14 and 16 thus enable all of the data packets conveyed using the BGP4 protocol to be extracted from the traffic on the network 2, but without interfering with the operation of the network.

The data packets complying with the BGP4 protocol are detected as they are being processed by the equipment 4ᵢ and they are copied without being extracted.

The collection operation is thus transparent from the point of view of the network 2.

At the end of step 10, all of the data conveyed in the operational network 2 via the node 4ᵢ and using the BGP protocol has been copied by the collector means 6.

During the collection step, the collector means 6 are therefore placed in series in the links and collect the data coming into and going out from the node 4ᵢ. In this case, the data internal to the node 4ᵢ is not collected by the collector means 6.

Advantageously, the copying substep 14 also serves to copy time and date information associated with each data packet so as to conserve the time sequencing of exchanges of these data packets between the various routers of the operational network 2.

These collected data packets are then stored during a step 20 in the database 8.

In the event of the time and date information also being copied by the collector means 6 during the substep 14, this time and date information is likewise stored in the database 8.

The method then comprises a step 30 of modifying the collected data packets.

In the implementation described, this step 30 comprises a substep 32 of cleaning the data packets, in particular for the purpose of removing certain execution fields that are of no use in the context of the tests being performed, such as, for example in a test of protocol performance for the BGP4 protocol: the fields known as 37 withdrawn” or the attributes known as “MP-UNREACH-NLRI”.

Modification step 30 comprises a substep 34 of replacing in the collected data packets data for identifying the original senders and receivers of the packets with data identifying senders and receivers in the test environment.

In the operational network 2, a large number of routers are involved, thereby increasing the number of packet senders and receivers in a way that cannot be reproduced in the context of a test environment.

This replacement substep 34 corresponds, for example, to grouping together a plurality of original receiver and sender identities to coincide with each receiver and sender identifier in the test environment.

More particularly, in the context of the BGP4 protocol, this substep 44 corresponds to grouping together so-called “BGP-UPDATE” packets as a function of the packet sender, by using the “ORGINATOR-ID” and/or the “NEXT-HOP” attributes as discriminators.

Advantageously, the modification step 30 also includes other substeps of modifying the collected data packets for the purpose of simulating other situations. For example, the step 30 includes a substep 36 of modifying the content of the attributes of functions present in the data packets in order to have data packets including these differing functions in a maximum of different situations.

In the context of the BGP4 protocol, the attributes whose values are modified during this substep 36 are constituted, for example, by the so-called “AS-PATH”, “NEXT-HOP”, and “CLUSTER-LIST” attributes.

In the implementation described, the modification step 30 also includes a substep 38 of adding data packets in order to introduce elements that are additional compared with the data packets collected from the operational network 2, such as, for example: data packets that come from virtual additional pieces of equipment.

Finally, step 30 includes a substep 40 of modifying the time and date information of data packets in order to modify the time sequencing with which the data packets are transmitted, in order to slow them down or to speed them up.

At the end of step 30, the method thus delivers data packets collected from the operational network 2 and modified so as to be configured for the test environment, and advantageously so as to cover a wide range of protocol events.

The collected and modified data packets are then stored in the database 8 during a step 42.

Thereafter, the method includes a step 50 of testing the router DUT.

In the embodiment described, this test step 50 begins with a substep 52 of configuring the test environment.

The BGP4 protocol is a so-called “connected” protocol, so the various receivers and senders must communicate within sessions that have been opened between an identified sender and an identified receiver via a router.

During this substep 52, it is therefore necessary to set up sessions between the various pieces of equipment in the test environment in order to create the test topology, allowing each piece of equipment to perform a plurality of send and receive functions.

The substep 52 is followed by a substep 54 of sharing the collected and modified data packets between the various pieces of equipment in the test environment, each data packet being allocated to its sender as defined at the end of substep 34.

Finally, step 50 includes a substep 56 of the DUT router routing the collected and modified data packets through the isolated test environment.

This substep 56 corresponds to each of the pieces of equipment for transmitting the various incoming data packets as a function of the associated receiver information and advantageously also the time and date information. This substep 56 thus enables the DUT router to be put into a test situation that is representative of a real situation. Advantageously, the situation to which the DUT router is exposed is modified in order to cover a large number of functions, and possibly also an increase in network traffic loading, so as to be able to evaluate the protocol performance of the DUT router compared with a node of the network, and as a function of the present and real loading of said node, and also as a function of loading that has been modified compared with the present situation.

Finally, the method of the invention includes a step 60 of collecting data concerning measurement of the protocol performance of the DUT router, which is done in conventional manner for the purpose of determining in particular memory occupation, loading of the central processor unit (CPU), convergence time, and other characteristics of the DUT router.

In addition, the outgoing data of the tested routers is compared to the collected outgoing data so as to verify the conformity of the protocol.

Such a test method is particularly well adapted to routers that are to perform a route reflector function in the BGP4 protocol. Such routers serve as entry points to a plurality of other routers and so they occupy a strategic position in the BGP4 topology of the network, so their protocol performance is critical.

Such a method is also suitable for testing routers that are going to handle a large number of routes, such as routers using an extension of the so-called “MP-BGP” type, because of the significant increase in the number of routes of the VPN-IPv4 type.

Naturally, other variants of the invention are also possible.

In particular, the invention may be applied to other protocols, such as so-called “IGP” or “multicast” protocols, and in particular non-connected protocols known as “broadcast protocols” enabling information to be sent and received independently of sessions that have been set up beforehand, such that in such an implementation, substep 52 is not performed.

When the DUT router is to replace an existing router, the collection step 10 is performed directly on the router that is to be replaced. When the network is being extended, the node on which collection is performed is selected during substep 12 in such a manner as to be representative of the future loading of the router.

Furthermore, the collection step 10 can be implemented on one or more protocols, and possibly on all of the protocol data packets conveyed over the network, with substeps 14 and 16 being adapted accordingly.

Furthermore, collection means other than those described may be used, and executing them may implement different types of equipment and different protocols.

In a variant, the data collected during step 10 is processed directly in real time, making intermediate storage steps 20 and 42 pointless.

Depending on the protocol(s) selected, processing step 30 may include additional substeps or need not include all of the substeps described.

In particular, each of the cleaning substep 32, the modification substep 36, the additional substep 38, and the time and date information modification substep 40 could be omitted without affecting the effectiveness and the implementation of the method.

In a variant, the test relates to the DUT router performing a given function so that successful or unsuccessful performance of this function constitutes the result of the test, leading to the DUT router being stopped, for example, and thus making step 60 pointless.

Finally, in another variant, the isolated test environment includes a limited number of routers connected to the DUT router and acting to transmit data packets, in which case substep 54 can be omitted.

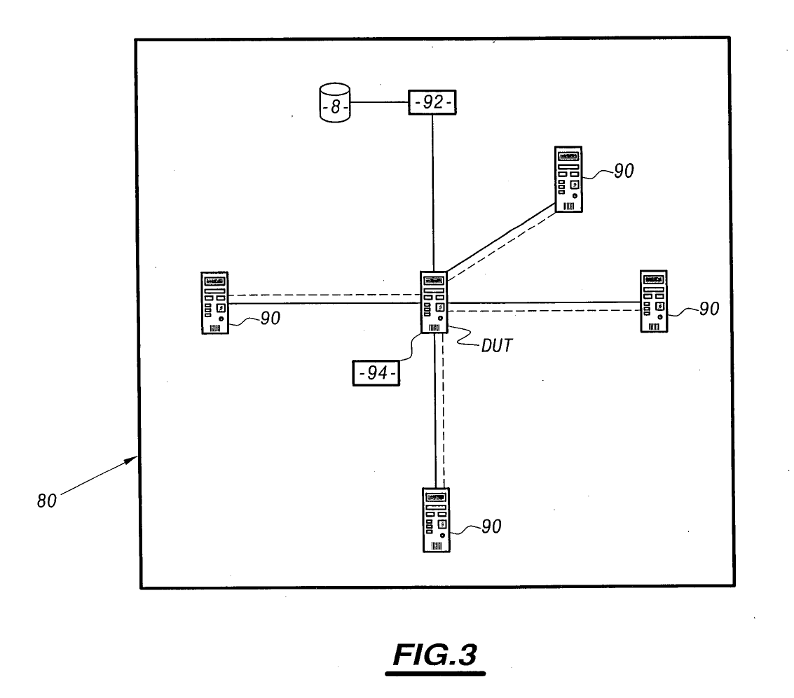

FIG. 3 shows a test system 80 in which the method of the invention is implemented.

This test environment system 80 comprises the router under test, referenced DUT, that is connected to a determined number of routers 90 for simulating a network. Each router 90 is connected to the DUT via a physical link and one or more virtual links.

In particular, in the context of testing protocol performance performed on the BGP4 protocol, each router 90 is connected over a plurality of virtual links with the router DUT, each virtual link corresponding to a session that is open between a router 90 and the router DUT.

The set of routers 90 and the router DUT thus constitutes a network of small topology, but nevertheless providing a medium for simulating the operational network 2.

The routers 90 and DUT are all controlled by a control unit 92 serving to determine respective functions and attributions, with the control unit itself being connected to the database 8 containing the collected and modified data packets that are used for simulating the activity of the operational network 2.

Finally, the router DUT is connected to means 94 for measuring its protocol performance in conventional manner.

In operation, the control unit 92 configures the test environment network 80 by implementing the steps 52, so as to set up virtual links between the router DUT and the routers 90 as are required for running BGP4 sessions. Thereafter, the control unit 92 uses the data packets from the database 8 corresponding to the data packets collected in step 10 of the method of the invention and modified in step 30.

The data packets are distributed amongst the various routers 90 so that each router has all of the data packets it is required to send to the other routers 90 via the router DUT. This distribution corresponds to implementing step 54 of the method of the invention.

Finally, the control unit 92 initiates step 56 of routing data packets via the router DUT, by causing each of the routers 90 to send the data packets that have been allocated thereto.

Throughout this stage of operation, the measurement means 94 measure the performance of the router DUT in application of step 60.

The method of testing the routers DUT and in particular the steps 30, 50 of modifying collected data packets and of testing the routers, are executed by a computer of the test system under the control of a computer program. The invention therefore also relates to a computer program including program-code instructions for implementing the steps of the method of testing the DUT as described above, when said program operates on the computer of the test system.

Naturally, various architectures could be envisaged. In particular, each of the routers 90 could have direct access to the database 8 in order to extract therefrom these data packets that it is supposed to send.

1. A method of testing a router in a test environment isolated from an operational telecommunications network, wherein, after collecting data from a node of said operational network by copying data packets being conveyed thereby, said method comprises:
a step of modifying collected data packets, this step comprising at least one substep of replacing the identity data of the original senders and receivers of the collected packets with identification data for senders and receivers in the test environment; and
a step of testing the router and comprising at least one substep of routing modified data packets via said router in said test environment.

2. A method according to claim 1, wherein the collection includes a substep of positioning collector means at a node of said operational network having characteristics that are similar to those of the future position for the router.

3. A method according to claim 1, wherein the collection includes a substep of selecting from the copied data packets, data packets that correspond to one or more determined protocols.

4. A method according to claim 1, wherein said copying substep includes copying time and date information associated with said copied data packets.

5. A method according to claim 4, wherein said modification step includes a substep of modifying the time and date data associated with said data packets.

6. A method according to claim 1, wherein said modification step comprises at least one substep selected from the group constituted by:
a cleaning substep for cleaning collected data packets;
a modification substep for modifying parameters of collected packets; and
an addition substep for adding parameters to the collected data packets.

7. A method according to claim 1, wherein said test step includes a substep of configuring the test environment to determine the network topology.

8. A method according to claim 1, wherein said test step includes a substep of distributing collected and modified data packets between various routers for simulating the test environment prior to causing said router under test to perform said substep of routing packets.

9. A method according to claim 1, including a step of measuring the performance of the router under test during said test step.

10. A test system isolated from an operational telecommunications network, the system being of the type comprising one or more simulation routers connected to a router under test, a database containing test data packets, and a control unit suitable for controlling routing by said simulation routers of data packets from said database through said router under test, wherein said database contains data packets collected from a node of an operational network and modified in order to replace the identity data of the original senders and receivers of the data packets collected with identification data for senders and receivers in the test environment.

11. A system according to claim 10, the system being adapted to implement a test method according to claim 1.

12. A computer program for a test system, the program comprising program-code instructions for implementing the steps of the method according to claim 1, when said program operates on a computer of the test system.
